(19) United States
(12) Patent Application Publication
(10) Pub. No.: US 2007/0300259 A1
(43) Pub. Date: Dec. 27, 2007

(54) SYSTEMS AND METHODS TO SUPPORT MULTIPLE PROGRAM GUIDES IN A HOME NETWORK

(76) Inventor: Peter Chan, Suwanee, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/423,253

(22) Filed: Jun. 9, 2006

(51) Int. Cl. H04N 5/445

(52) U.S. Cl. 725/46

(57) ABSTRACT

The present invention is directed towards enabling systems and methods for customizing and providing multiple interactive program guides (IPGs) for each member in a household. Once determined which member(s) is in the room watching television, the associated customized IPG is displayed. If there are multiple members in the room watching television, a customized combined IPG may be displayed. The present invention determines who is in the room by one of toggling buttons on a remote control; a GUI screen displaying the multiple members; facial recognition; Bluetooth or wireless technology, to name but a few.

### TECHNICAL FIELD

The present invention is generally related to a communications system and, more particularly, is related to multiple program guides in one home network.

### BACKGROUND OF THE INVENTION

Currently, an interactive program guide (IPG) displays all of the services shown on different channels that a service provider has available. A subscriber can view the IPG and select a program from one of the channels to view, record, or purchase. A subscriber may also personalize the IPG by selecting desired services (e.g., Fox News Network (FNN), The Weather Channel (TWC), Home Box Office (HBO), etc.) for a favorites list. The favorites list may then be selected and displayed in the IPG without showing any of the other non-selected services. However, only one favorites list can be programmed into a set-top box (STB). There is a need, therefore, for systems and methods that allow a subscriber having multiple members in a household the ability to customize multiple IPGs depending upon who is in the room.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a digital broadband delivery system (DBDS) that provides services to a plurality of digital host communication terminals (DHCTs).

FIG. 2 is an illustration of an abridged IPG that is suitable for use in the DBDS of FIG. 1.

FIG. 3 is an illustration of a first customized IPG for a first member that includes just selected channels or services in accordance with the present invention.

FIG. 4 is an illustration of a second customized IPG for a second member that includes just selected channels or services in accordance with the present invention.

FIG. 5 is a block diagram of a digital communications host terminal (DHCT) that is suitable for use in customizing and storing the configurations for the customized IPGs of FIGS. 3 and 4.

FIG. 6 illustrates an example remote control that is used in conjunction with the DHCT of FIG. 5 for customizing the IPGs of FIGS. 3 and 4.

FIG. 7 illustrates an example Menu graphical user interface (GUI) 700 that is displayed and used to set up the members and their customized IPG in accordance with the present invention.

FIG. 8 illustrates an example Member Selection graphical user interface (GUI) that is displayed for selecting one ore more customized IPGs.

FIG. 9 illustrates a customized IPG for Members 1 and 2 in accordance with the present invention.

FIG. 10 illustrates an IPG received from the service provider including an option that the user can select to jump to the Member Selection GUI in accordance with the present invention.

### DETAILED DESCRIPTION OF THE PREFERRED EMBODIMENTS

The preferred embodiments of the invention now will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art. Furthermore, all “examples” given herein are intended to be non-limiting.

The present invention is directed towards the enablement of allowing a subscriber to configure multiple versions of an interactive program guide (IPG) and subsequently display a custom IPG depending upon who is in the room watching television. More specifically, each member of the household may have certain services that they consistently select while disregarding all other services. In this manner, an abridged list of channels and the corresponding services, both viewed from the IPG and accessed by scrolling through the channels, may be desired. According to the present invention, a customized IPG displays only selected services according to each member of the household. Additionally, if multiple members of the household are in the room watching television, a configurable IPG may be presented that combines both member's customized list.

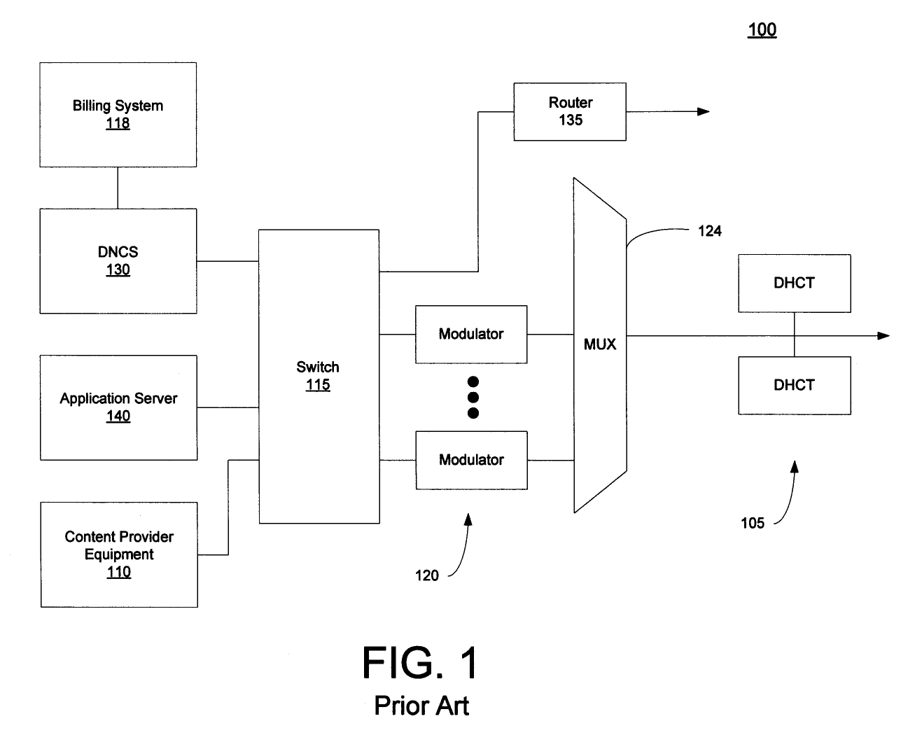

FIG. 1 is a block diagram of a digital broadband delivery system (DBDS) 100 that provides services to a plurality of digital host communication terminals (DHCTs) 105. Briefly, different services each including a plurality of programs is received via content provider equipment 110 from multiple source providers. Among many functions, the content provider equipment 110 prepares the services and forwards them to a switch 115. The switch 115 typically routes the services to a plurality of modulators 120 for delivery, but may also route the services to a router 135 for delivery over Ethernet IP depending upon the application. The modulators 120 modulate the services into a data channel that typically transmits eight or more digital services, and the transmitted data is subsequently combined via a multiplexer 124. The combined stream is then broadcasted to the plurality of DHCTs 105. Since the combined stream is broadcasted to all of the DHCTs 105, the DHCTs 105 are given authorization codes via a billing system 118 to decrypt certain services depending upon their subscription status.

Also included in the DBDS 100 is a digital network control system (DNCS) 130 that controls all the DBDS devices in the system 100. Data is typically entered into the DNCS 130 by a system operator. For example, based on information entered into the DNCS 130, the modulators 120 generate packets containing MPEG-2 program-specific information and system information. The modulators 120 then insert this information into the outgoing transport stream. Additionally, the DNCS 130 retrieves IPG data for each service from an application server 140. It will be appreciated that the application server 140 normally receives IPG data, which includes program names, times, and dates, from an IPG vendor 145. After retrieving the IPG data, the application server 140 decompresses the file and places the data in a database for access by the DNCS 130. The IPG data is then typically provided in-band along with the streamed services and data as well as out-of-band directly to an IPG client application that is resident on the DHCT 105. The IPG lists current and upcoming programs for each service. Additional functions of the DNCS 130 include provisioning the received services. Some services, like FOX Sports World (FOXSW) and Bravo (BRVO), may be offered to all subscribers and broadcasted in the clear or they may be encrypted and offered as a subscription-based channel. Each service is then assigned a channel on a channel map. Subscribers can then choose a service by selecting its associated channel either by tuning to the channel or by selecting it from the IPG.

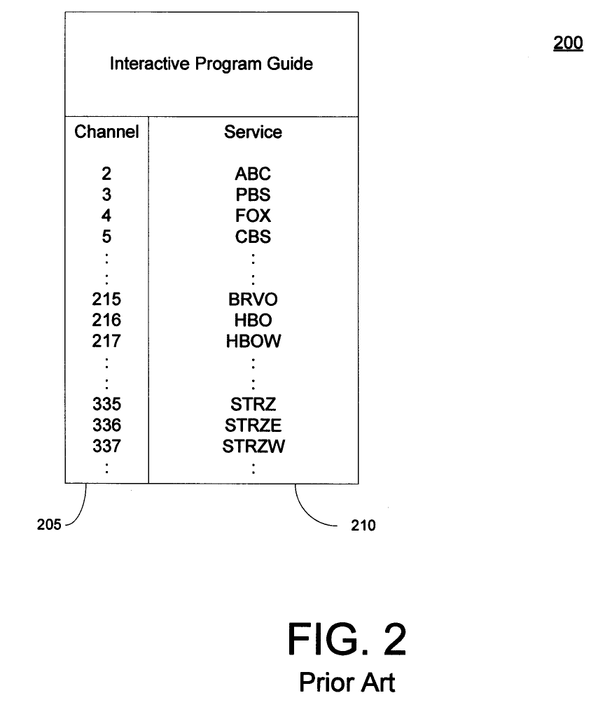

FIG. 2 is an illustration of an abridged IPG 200 that is suitable for use in the DBDS of FIG. 1. A channel line-up 205 is displayed where each channel corresponds to a service 210. As mentioned, all channels and services are displayed in the default IPG 200. A viewer who only watches typically 5 or 6 channels may not want to scroll through over 100 channels to view what programs are coming up on the 5 or 6 channels, or services. Accordingly, a viewer may wish to configure or customize the default IPG 200 to view just the 5 or 6 selected channels that are predominantly watched.

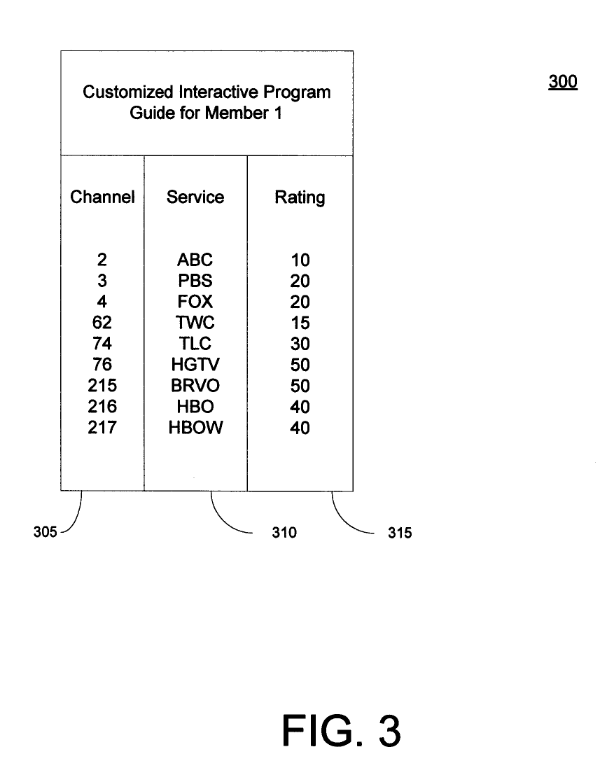

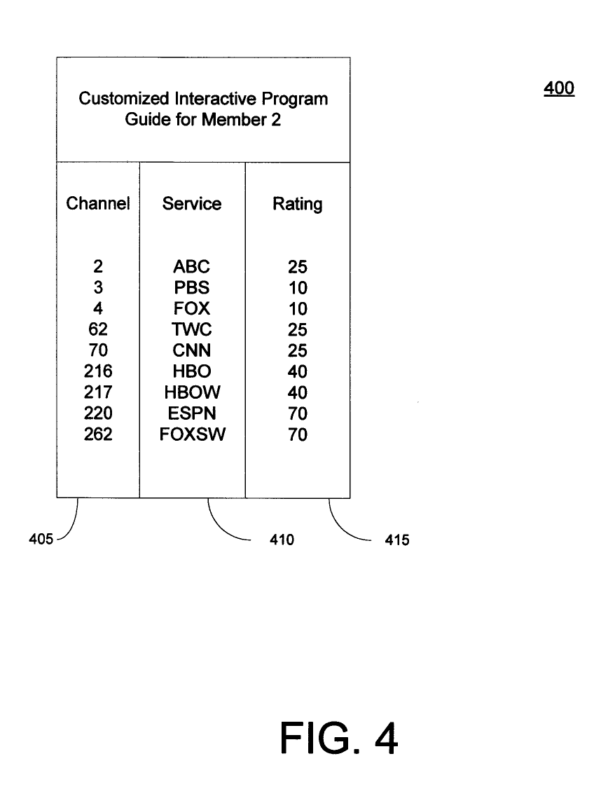

FIG. 3 is an illustration of a first customized IPG 300 for a first member that includes just selected channels or services in accordance with the present invention. The customized IPG 300 is configured to include just the channels 305 and corresponding services 310 that the first member predominantly views. In this manner, when the customized IPG for the first member is selected, just the selected channels are displayed. Additional customized IPGs may be configured for additional members of the household. For example, FIG. 4 is an illustration of a second customized IPG 400 for a second member that includes just selected channels or services in accordance with the present invention. The IPG 400 is customized by selecting channels 405 and corresponding services 410 that the second member predominantly watches. Additional information may be added to the custom IPG, such as a personal rating 315, 415 or other weighting information, for each service. More specifically, the rating and weighting information for a particular channel represents the member preference for that channel. This preference is represented by a value instead of the traditional binary inclusion or exclusion setting.

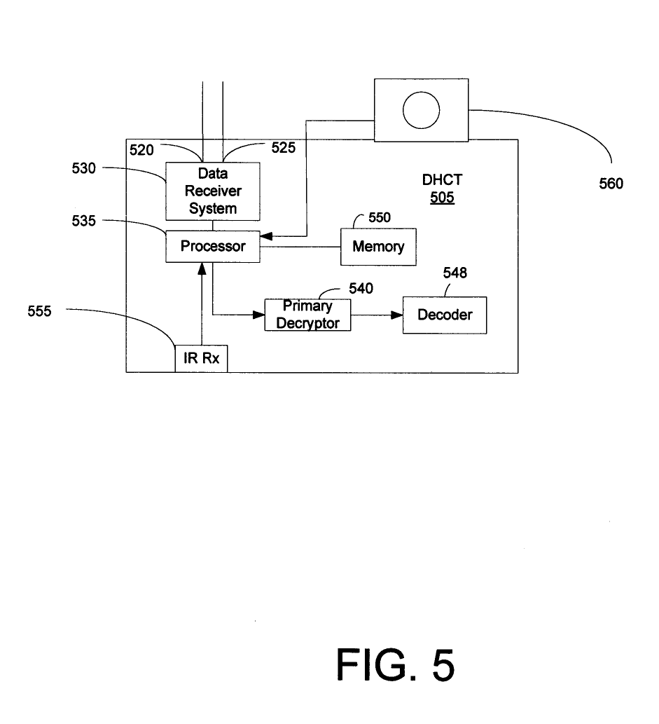

FIG. 5 is a block diagram of a digital communications host terminal (DHCT) 505 that is suitable for use in customizing and storing the configurations for the customized IPGs of FIGS. 3 and 4. A data receiver system 530, such as a tuner system, receives in-band data, such as streaming programs for each service, at port 520 and out-of-band data, such as the default IPG, at port 525. A processor 535 instructs the data receiver system 530 to filter a requested service for either displaying on a television or other display screen (not shown) or for storing in memory 550. Subsequently, a primary decryptor 540 decrypts the service and provides the decrypted service to a decoder 548 for decoding prior to displaying. Additionally, the processor 535 receives the default IPG from the data receiver system 530 and stores it in memory 550 and/or displays on the display screen. Memory may also reside in the headend server systems, such as the DNCS 130 or the application server 140. Furthermore, an IR (infrared) receiver 555 receives IR signals from a remote control for such things as volume control, channel changes, invoking the IPG, etc.

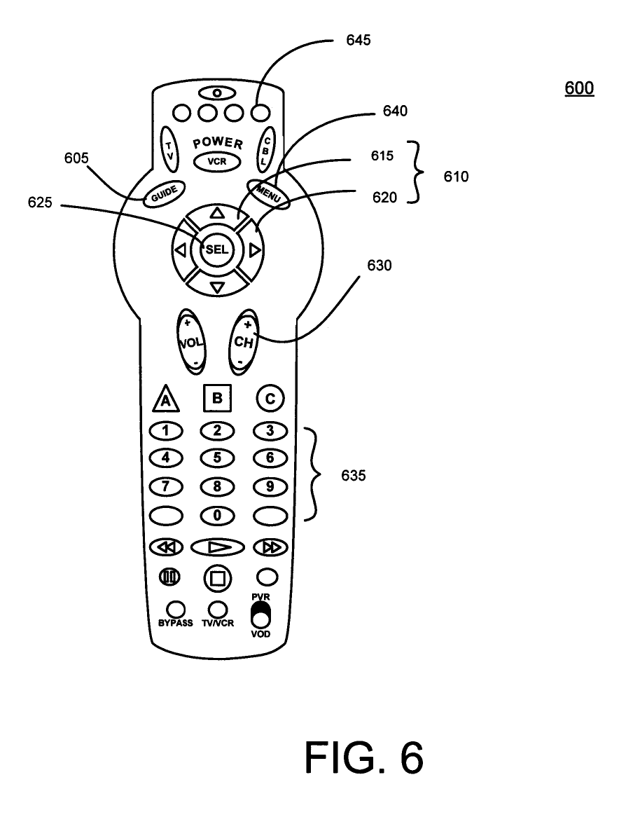

FIG. 6 illustrates an example remote control 600 that is used in conjunction with the DHCT 505 of FIG. 5 for customizing the IPGs of FIGS. 3 and 4. Briefly, the IPG is accessed by pressing a GUIDE button 605 on the remote control 600, and the IPG is then displayed on the display screen. Directional arrows 610, such as the up arrow 615 and the right arrow 620, are used to navigate throughout the IPG. A SEL button 625 is then used to select certain programs or commands that are displayed. When watching television, a channel button 630 manually changes the channel either up or down. Additionally, a numeric keypad 635 may be used to enter numbers to select a certain channel or to enter numbers for some other command.

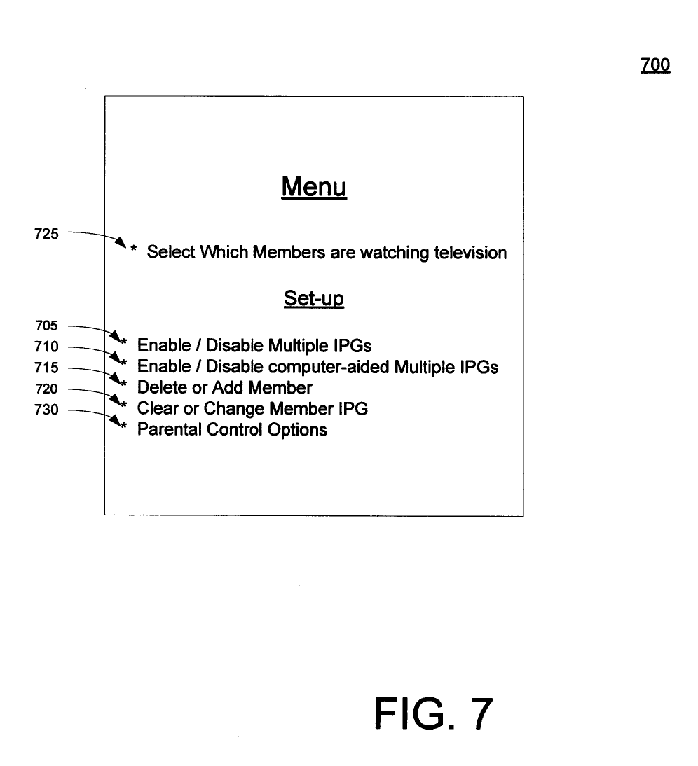

FIG. 7 illustrates an example Menu graphical user interface (GUI) 700 that is displayed and used to set up members and their customized IPG in accordance with the present invention. The Menu GUI 700 may be a main menu that allows the user to select many different options, but only the customized IPG option is addressed in this application. A menu button on the default IPG 220 may be selected or a menu button 640 on the remote control 600 may be pressed to access the Menu GUI 700. There may then be several options relating to the customized IPG. Such options include: enabling or disabling the multiple IPGs 705; enabling or disabling a computer-aided function that generates multiple IPGs 710 based on each member's predominantly watched channels, for example; deleting or adding a member 715; and clearing or changing a member's customized IPG 720. Once a member is added from the ‘deleting and adding a member’ screen 715 and their services selected from the ‘clear or exchange member IPG’ screen 720, the customized IPG is saved in memory 550. The customized IPGs, such as shown in FIGS. 3 and 4, can then be invoked by then selecting ‘which member(s) is watching television’ screen and choosing a member(s) from the list.

Each member may be set up by the ‘deleting and adding a member’ screen 715, which prompts a user to enter a name for each member. Additionally, the user may associate a unique button 645 on the remote control 600 to each member. The unique button 645 may subsequently be pressed to invoke that member's list either on the IPG or while manually scrolling through the channels. The unique button 645 may also be an LED button that lights to identify which member's list is currently active. The members can then toggle among the unique buttons 645 to activate or deactivate each member's customized IPG list.

The channel, or services, can be selected and saved in conjunction with a member in various ways. A first way is through the Menu GUI 700 and selecting ‘clear or change member IPG’ 720. A further way to select channels is via the remote control 600. More specifically, once a member has been defined, the default IPG 200 can be subsequently displayed. The member may scroll through the channels and press the select button 625 on a highlighted channel, which then adds that channel to the member's list. Additionally, the member's unique button 645 may be pressed on a highlighted channel for a longer duration, which selects the channel. Similarly, a channel that is currently being viewed on the television may be selected in this way as well. During a channel change, a channel banner indicates in some manner (e.g., words, a color icon, etc.) that channel is either on the active member's customized list or not. If the channel is not on the IPG list and the viewer wishes to save it to their list, the associated unique button 645 is pressed for a few moments. Subsequently, the channel banner changes indicating the change from inactive to active.

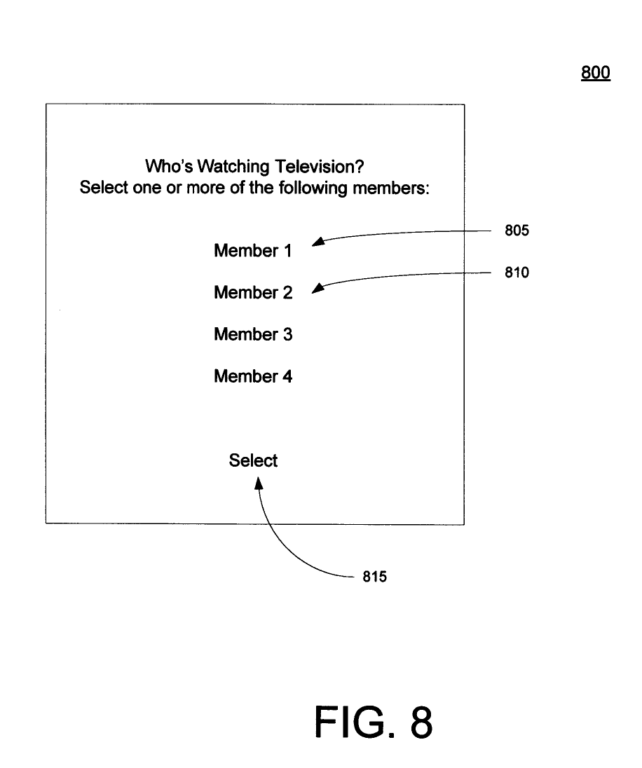

FIG. 8 illustrates an example member selection graphical user interface (GUI) 800 that is displayed on the display screen 510 for selecting one or more of the customized IPGs. In this example, a subscriber has previously entered four members that are associated with four stored customized IPGs. The member selection GUI 800 may also be displayed initially upon powering up the DHCT 505 depending upon the user's preference. Using the directional buttons 610 on the remote control 600, a user may scroll down the list of members and highlight one or more. For example, if members 1 and 2 are watching television, the user presses the SEL button 625 for Member 1 805, then presses the down arrow on the directional buttons 610 to highlight Member 2 810, and subsequently presses the SEL button 625 for Member 2. When finished, the user presses the down arrow to highlight Select 815 and finally presses the SEL button 625 to complete the process.

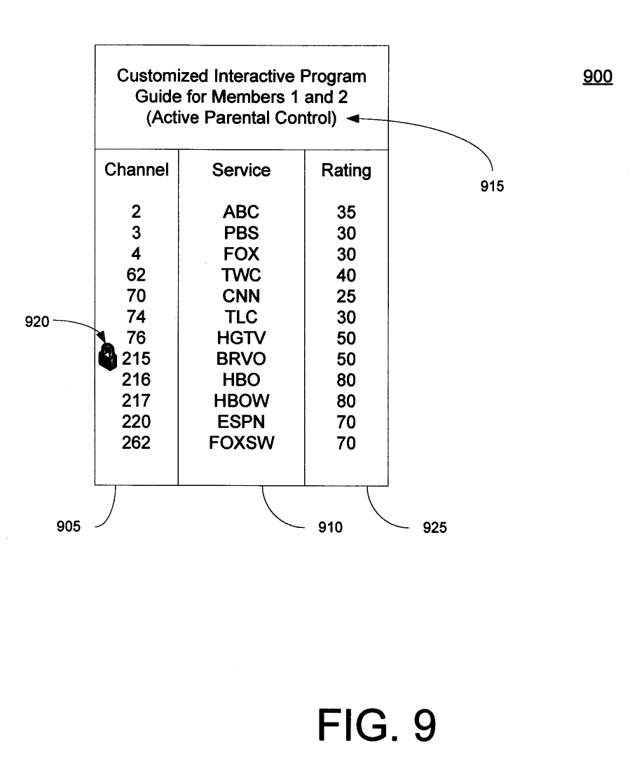

FIG. 9 illustrates a customized IPG for Members 1 and 2 in accordance with the present invention. More specifically, the customized IPG 900 is a combined IPG that includes the channels 905 and corresponding services 910 for both members 1 and 2. The combined IPG 900 is displayed after the Member Selection GUI 800 of FIG. 8 established that both members were actively watching television. If there were additional members watching television, the combined IPG would also include their customized channels in addition to members 1 and 2. The combined IPG can be configurable in numerous ways, such as using a combined rating 925 for each service. If one member rated one channel at 10% (e.g., the first member's personal preference gave a rating of 10% to ABC) while another member's personal preference rated that same channel at 25%, then that channel may be displayed with a combined rating of 35% on the combined IPG 900. It may be configurable by the members that only those channels with a combined rating of 40% be displayed on the combined IPG 900. Furthermore, parental control settings will transfer over to the combined IPG, if applicable, and shown as “Active Parental Control” 915. More specifically, a member may set up parental controls for some services so that they are not available to the younger members, for example. If channel 215 showing the service BRVO is selected to be unavailable for member 2, but available for member 1, then an icon 920, such as a lock, may be shown next to the channel number or service name. In this manner, BRVO on channel 215 is locked in IPG 900 and may be unlocked if a personal identification number (PIN) is entered. The parental control may be deactivated in the MENU GUI 700 (FIG. 7) under parental control options 730. A deactivated parental control may also be illustrated in the IPG 900 as “Deactivated Parental Control,” if desired.

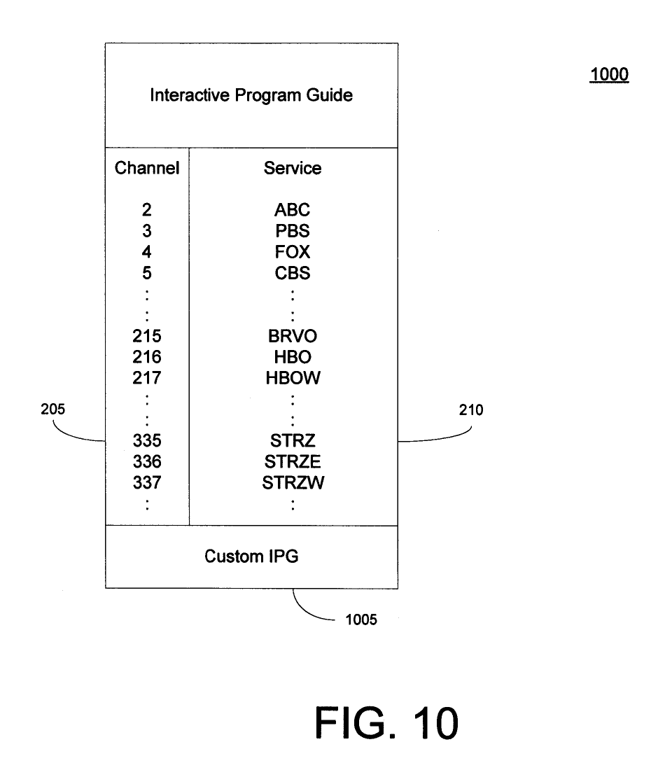

FIG. 10 illustrates an IPG received from the service provider including an option that the user can select to jump to the Member Selection GUI 800 in accordance with the present invention. A user can invoke the IPG by pressing the GUIDE button 605 on the remote control 600. A Custom IPG 1005 selection is available for the user to select. Other options for determining which customized IPG to display include presenting the Member Selection GUI 800 when powering on the DHCT 505; programmed unique buttons 645 (FIG. 6) that associate each member with a customized IPG; a function button 640 and number one on the numeric keypad 635 may represent that member 1 is actively watching television; facial recognition software along with a camera 560 that determines who is in the room watching television; or Bluetooth technology can be used that associates each member with a Bluetooth tag that identifies who is in the room, to name some examples.

Accordingly, systems and methods have been described that enable a subscriber to customize multiple IPGs that are subsequently presented when a member is actively watching television. It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and protected by the following claims.

1. A method of presenting a plurality of customized interactive program guides (IPGs) in a home network, the method comprising the steps of:
configuring a plurality of customized IPGs, wherein each customized IPG includes a member identification (ID) and desired channels selected from a default IPG;
storing the plurality of customized IPGs; and
upon receiving notification, presenting at least one of the plurality of customized IPGs based upon the member ID.

2. The method of claim 1, further comprising the steps of:
receiving notification for more than two member IDs;
retrieving the associated customized IPGs from memory; and
combining the more than two customized IPGs to present a combined customized IPG.

3. The method of claim 1, further comprising the steps of:
upon request, presenting a member selection GUI including each configured member ID,
wherein notification to present at least one of the plurality of customized IPGs is selected from the member selection GUI.

4. The method of claim 1, further comprising the steps of:
upon powering on, presenting a member selection GUI including each configured member ID,
wherein notification to present at least one of the plurality of customized IPGs is selected from the member selection GUI.

5. The method of claim 1, further comprising the steps of:
detecting via a camera and facial recognition software each configured member in close proximity of the camera; and
retrieving the detected member's customized IPG,
wherein if there are more than one detected member, then combining the more than one detected member's customized IPG to provide a combined IPG.

6. The method of claim 1, further comprising the steps of:
detecting via a wireless identification tag each configured member in close proximity; and
retrieving the detected member's customized IPG,
wherein if there are more than one detected member, then combining the more than one detected member's customized IPG to provide a combined IPG.

7. The method of claim 1, further comprising the steps of:
for each customized IPG, designating which channels from the default IPG have parental control, thereby requiring an identification key to present each parental controlled channel; and
when presenting the at least one of the plurality of customized IPGs, displaying an icon next to each of the parental controlled channels.

8. The method of claim 2, wherein the combined customized IPG is determined by adding a service to the combined customized IPG based on rating and weighting data for each selected channel for the more than two member IDs.

9. A device for presenting a plurality of customized IPGs in a home network, the device comprising:
a tuner system for receiving a default IPG;
a processor for presenting a menu GUI for configuring a plurality of customized IPGs, wherein each customized IPG includes a member identification (ID) and desired channels selected from the default IPG; and
memory for storing the plurality of customized IPGs,
wherein when notification is received, the processor provides at least one of the plurality of customized IPGs based upon the received member ID.

10. The device of claim 9, further including an IR receiver for receiving IR signals from a remote control, wherein the remote control transmits signals in conjunction with the menu GUI for configuring the plurality of customized IPGs.

11. The device of claim 9, wherein the plurality of customized IPGs is combined to provide a combined customized IPG for each received member ID.

12. The device of claim 11, wherein the combined customized IPG for each received member ID is determined by a programmable formula and rating for on the selected channels selected by each received member ID.

13. The device of claim 9, wherein upon powering on the device, presenting a member selection GUI including each configured ID, wherein the received notification to present at least one of the plurality of customized IPGs is selected from the member selection GUI.

14. The device of claim 9, wherein the notification is a member ID of a member who is in close proximity of the device, wherein the member ID is determined via a camera and facial recognition software.

15. The device of claim 9, wherein the notification is a member ID associated with a wireless identification tag that is in close proximity of the device.
